(19) United States
(12) Patent Application Publication
(10) Pub. No.: US 2014/0229654 A1
(43) Pub. Date: Aug. 14, 2014

(54) Garbage Collection with Demotion of Valid Data to a Lower Memory Tier

(71) Applicant: SEAGATE TECHNOLOGY LLC, Cupertino, CA (US)

(72) Inventors: Ryan James Goss, Prior Lake, MN (US); David Scott Ebsen, Minnetonka, MN (US); Mark Allen Gaertner, Vadnais Heights, MN (US)

(73) Assignee: SEAGATE TECHNOLOGY LLC, Cupertino, CA (US)

(21) Appl. No.: 13/762,448

(22) Filed: Feb. 8, 2013

(51) Int. Cl. G06F 12/02

(52) U.S. Cl. CPC G06F 12/0253; G06F 12/0246
USPC 711/103

(57) ABSTRACT

Method and apparatus for managing data in a memory. In accordance with some embodiments, a first tier of a multi-tier memory structure is arranged into a plurality of garbage collection units (GCUs). Each GCU is formed from a plurality of non-volatile memory cells, and is managed as a unit. A plurality of data sets is stored in a selected GCU. A garbage collection operation is performed upon the selected GCU by identifying at least one of the plurality of data sets as a valid data set, migrating the valid data set to a non-volatile second tier of the multi-tier memory structure, and invalidating a programmed state of each of the plurality of non-volatile memory cells to prepare the selected GCU for storage of new data. In some embodiments, the invalidating operation involves setting all of the memory cells in the selected GCU to a known storage state.

### SUMMARY

Various embodiments of the present disclosure are generally directed to managing data in a memory.

In accordance with some embodiments, a first tier of a multi-tier memory structure is arranged into a plurality of garbage collection units (GCUs). Each GCU is formed from a plurality of non-volatile memory cells, and is managed as a unit. A plurality of data sets is stored in a selected GCU. A garbage collection operation is performed upon the selected GCU by identifying at least one of the plurality of data sets as a valid data set, migrating the valid data set to a non-volatile second tier of the multi-tier memory structure, and invalidating a programmed state of each of the plurality of non-volatile memory cells to prepare the selected GCU for storage of new data.

In further embodiments, the migrated valid data are demoted to a lower tier in the memory structure, and the invalidating operation involves setting all of the memory cells in the selected GCU to a known storage state.

These and other features and aspects which characterize various embodiments of the present disclosure can be understood in view of the following detailed discussion and the accompanying drawings.

### BRIEF DESCRIPTION OF THE DRAWINGS

FIG. 1 provides is a functional block representation of a data storage device having a multi-tier memory structure in accordance with various embodiments of the present disclosure.

FIG. 2 is a schematic representation of an erasable memory useful in the multi-tier memory structure of FIG. 1.

FIG. 3 provides a schematic representation of a rewritable memory useful in the multi-tier memory structure of FIG. 1.

FIG. 4 shows an arrangement of garbage collection units (GCUs) that can be formed from groups of memory cells in FIGS. 2 and 3, respectively.

FIG. 5 illustrates exemplary formats for a data object and a corresponding metadata unit used to describe the data object.

FIG. 6A provides an illustrative format for a first data object from FIG. 5.

FIG. 6B is an illustrative format for a second data object from FIG. 5.

FIG. 7 is a functional block representation of portions of the device of FIG. 1 in accordance with some embodiments.

FIG. 8 depicts aspects of the data object storage manager of FIG. 7 in greater detail.

FIG. 9 shows aspects of the metadata storage manager of FIG. 7 in greater detail.

FIG. 10 represents an allocation cycle for GCUs from FIG. 4.

FIG. 11 depicts a garbage collection process in accordance with some embodiments.

FIG. 12 illustrates demotion of valid data from an upper tier to a lower tier in the multi-tier memory structure during the garbage collection operation of FIG. 11.

FIG. 13 is a flow chart for a DATA MANAGEMENT routine carried out in accordance with various embodiments of the present disclosure.

### DETAILED DESCRIPTION

The present disclosure generally relates to the management of data in a multi-tier memory structure.

Data storage devices generally operate to store blocks of data in memory. The devices can employ data management systems to track the physical locations of the blocks so that the blocks can be subsequently retrieved responsive to a read request for the stored data. The device may be provided with a hierarchical (multi-tiered) memory structure with different types of memory at different levels, or tiers. The tiers are arranged in a selected priority order to accommodate data having different attributes and workload capabilities.

The various memory tiers may be erasable or rewriteable. Erasable memories (e.g, flash memory, write many optical disc media, etc.) are made up of erasable non-volatile memory cells that generally require an erasure operation before new data can be written to a given memory location. It is thus common in an erasable memory to write an updated data set to a new, different location and to mark the previously stored version of the data as stale.

Rewriteable memories (e.g., dynamic random access memory (DRAM), resistive random access memory (RRAM), magnetic disc media, etc.) may be volatile or non-volatile, and are formed from rewriteable non-volatile memory cells so that an updated data set can be overwritten onto an existing, older version of the data in a given location without the need for an intervening erasure operation.

Metadata are often generated and maintained to track the locations and status of stored user data. The metadata tracks the relationship between logical elements (such as logical block addresses, LBAs) stored in the memory space and physical locations (such as physical block addresses, PBAs) of the memory space. The metadata can also include state information associated with the stored user data and the associated memory location, such as the total number of accumulated writes/erasures/reads, aging, drift parametrics, estimated or measured wear, etc.

The memory cells used to store the user data and metadata can be arranged into garbage collection units (GCUs) to provide manageable units of memory. The various GCUs are allocated as required for the storage of new data, and then periodically subjected to a garbage collection operation to reset the GCUs and return the reset GCUs to an allocation pool pending subsequent reallocation. The resetting of a GCU generally involves invalidating the current data status of the cells in the GCU, and may include placing all of the memory cells therein to a known data storage state as in the case of an erasure operation in a flash memory or a reset operation in a PCRAM. While the use of GCUs as a management tool is particularly suitable for erasable memory cells, GCUs can also be advantageously used to manage memories made up of rewritable memory cells.

A GCU may be scheduled for garbage collection based on a variety of data and memory related factors, such as read counts, endurance performance characteristics of the memory, the percentage of stale data in the GCU, and so on. When a GCU is scheduled for garbage collection, valid (current version) data may be present in the GCU. Such valid data require migration to a new location prior to the resetting of the various memory cells to a given state.

Various embodiments of the present disclosure provide an improved approach to managing data in a multi-tiered memory structure. As explained below, the memory cells in at least one tier in the multi-tiered memory structure are arranged and managed as a number of garbage collection units (GCUs). The GCUs are allocated for the storage of data objects and metadata units as required during normal operation.

At such time that a garbage collection operation is scheduled for a selected GCU, valid (current version) data in the GCU, such as current version data objects and/or current version metadata units, are migrated to a different tier in the multi-tiered memory structure. The selected GCU is then invalidated and returned to the allocation pool pending subsequent reallocation. Invalidation may include resetting all of the memory cells in the selected GCU to a common, known storage state (e.g., all logical “1's,” etc.).

In some embodiments, the migrated data are demoted to the next immediately lower tier in the multi-tier memory structure. In other embodiments, the lower tier may vary and is selected based on a number of factors. The demoted data object and/or the metadata unit may be reformatted for the new memory location.

The scheduling of the garbage collection operations can be based on a number of data and/or memory related factors. When a garbage collection operation is scheduled for a GCU having a set of stale (older version) data and a set of valid (current version) data, the current version data may generally tend to have a relatively lower usage rate as compared to the stale data. Demotion of the valid data to a lower tier thus frees the upper tier memory to store higher priority data, and provides an automated way, based on workload, to enable data sets to achieve appropriate levels within the priority ordering of the memory structure.

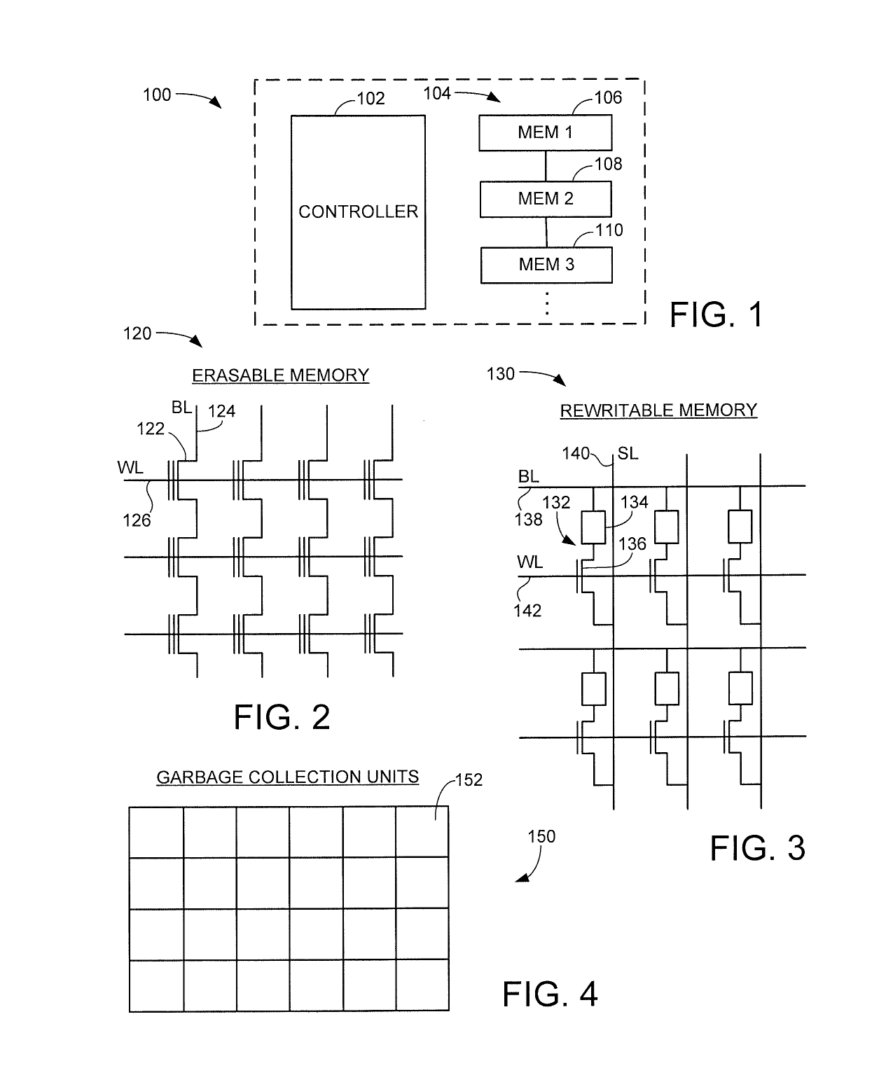

These and other features of various embodiments disclosed herein can be understood beginning with a review of FIG. 1 which provides a functional block representation of a data storage device 100. The device 100 includes a controller 102 and a multi-tiered memory structure 104. The controller 102 provides top level control of the device 100, and the memory structure 104 stores and retrieves user data from/to a requestor entity, such as an external host device (not separately shown).

The memory structure 104 includes a number of memory tiers 106, 108 and 110 denoted as MEM 1-3. The number and types of memory in the various tiers can vary as desired. Generally, a priority order will be provided such that the higher tiers in the memory structure 104 may be constructed of smaller and/or faster memory and the lower tiers in the memory structure may be constructed of larger and/or slower memory. Other characteristics may determine the priority ordering of the tiers.

For purposes of providing one concrete example, the system 100 is contemplated as a flash memory-based storage device, such as a solid state drive (SSD), a portable thumb drive, a memory stick, a memory card, a hybrid storage device, etc. so that at least one of the lower memory tiers provides a main store that utilizes erasable flash memory. At least one of the higher memory tiers provides rewriteable non-volatile memory such as resistive random access memory (RRAM), phase change random access memory (PCRAM), spin-torque transfer random access memory (STRAM), etc. This is merely illustrative and not limiting. Other levels may be incorporated into the memory structure, such as volatile or non-volatile cache levels, buffers, etc.

FIG. 2 illustrates an erasable memory 120 made up of an array of erasable memory cells 122, which in this case are characterized without limitation as flash memory cells. The erasable memory 120 can be utilized as one or more of the various memory tiers of the memory structure 104 in FIG. 1. In the case of flash memory cells, the cells 122 generally take the form of programmable elements having a generally nMOSFET (n-channel metal oxide semiconductor field effect transistor) configuration with a floating gate adapted to store accumulated charge. The programmed state of each flash memory cell 122 can be established in relation to the amount of voltage that needs to be applied to a control gate of the cell 122 to place the cell in a source-drain conductive state.

The memory cells 122 in FIG. 2 are arranged into a number of rows and columns, with each of the columns of cells 122 connected to a bit line (BL) 124 and each of the rows of cells 122 connected to a separate word line (WL) 126. Data may be stored along each row of cells as a page of data, which may represent a selected unit of memory storage (such as 8192 bits).

As noted above, erasable memory cells such as the flash memory cells 122 can be adapted to store data in the form of one or more bits per cell. However, in order to store new updated data, the cells 122 require application of an erasure operation to remove the accumulated charge from the associated floating gates. Accordingly, groups of the flash memory cells 122 may be arranged into erasure blocks, which represent a smallest number of cells that can be erased as a unit.

FIG. 3 illustrates a rewritable memory 130 made up of an array of rewritable memory cells 132. Each memory cell 132 includes a resistive sense element (RSE) 134 in series with a switching device (MOSFET) 136. Each RSE 134 is a programmable memory element that exhibits different programmed data states in relation to a programmed electrical resistance. The rewritable memory cells 132 can take any number of suitable forms, such as RRAM, STRAM, PCRAM, etc.

As noted above, rewritable memory cells such as the cells 134 in FIG. 3 can accept new, updated data without necessarily requiring an erasure operation to reset the cells to a known state. The various cells 132 are interconnected via bit lines (BL) 138, source lines (SL) 140 and word lines (WL) 142. Other arrangements are envisioned, including cross-point arrays that interconnect only two control lines (e.g., a bit line and a source line) to each memory cell.

FIG. 4 illustrates a memory 150 made up of a number of memory cells such as the erasable flash memory cells 122 of FIG. 2 or the rewritable memory cells 132 of FIG. 3. The memory cells are arranged into a number of garbage collection units (GCUs) 152. Each GCU 152 is managed as a unit so that each GCU is allocated for the storage of data, subjected to a garbage collection operation on a periodic basis as required, and once reset, returned to an allocation pool pending reallocation for the subsequent storage of new data. In the case of a flash memory, each GCU 152 may be made up of one or more erasure blocks of flash memory cells. In the case of an RRAM, STRAM, PCRAM, etc., each GCU 152 may represent a selected number of said memory cells arranged into rows and/or columns which are managed as a unit along suitable logical and/or physical boundaries.

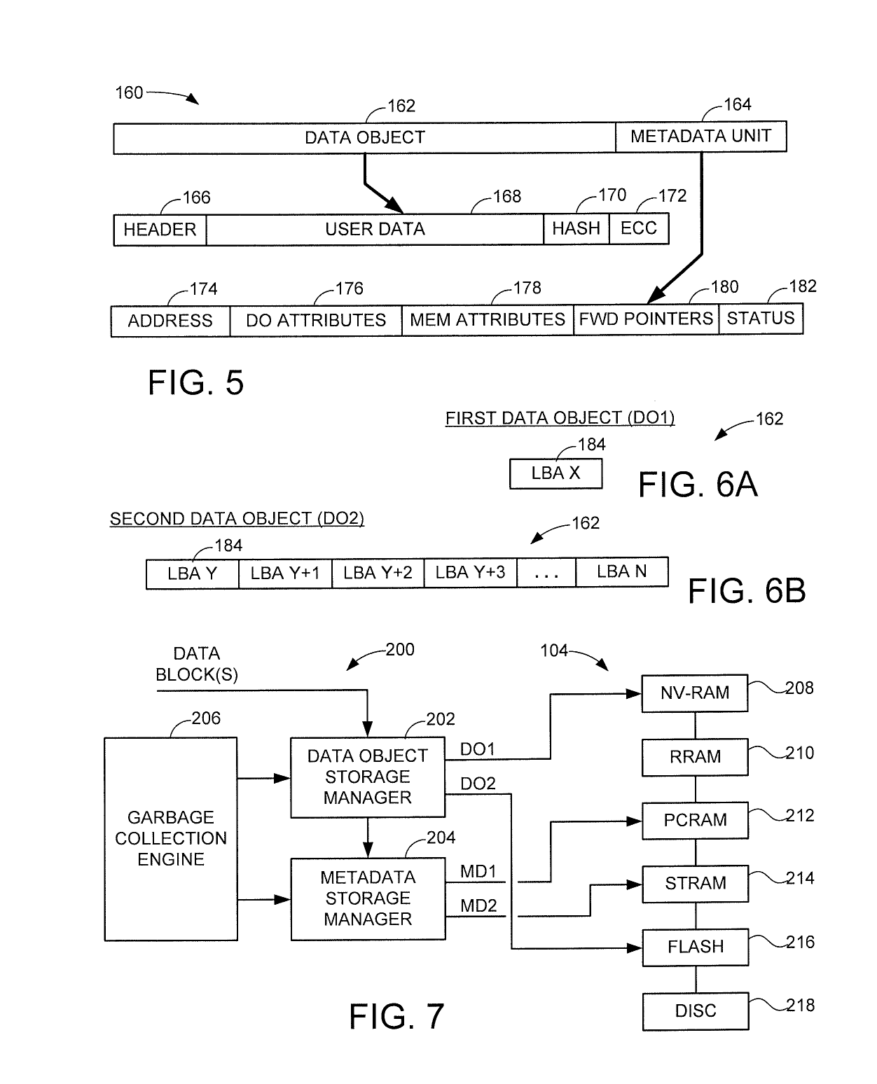

FIG. 5 illustrates exemplary formats for a data structure 160 comprising a data object 162 and an associated metadata unit 164. The data object 162 is used by the device 100 of FIG. 1 to store user data from a requestor, and the metadata unit 164 is used by the device 100 to track the location and status of the associated data object 162. Other formats for both the data object and the metadata unit may be readily used.

The data object 162 is managed as an addressable unit and is formed from one or more data blocks supplied by the requestor (host). The metadata unit 164 provides control information to enable the device 100 to locate and retrieve the previously stored data object 162. The metadata unit 164 will tend to be significantly smaller (in terms of total number of bits) than the data object 162 to maximize data storage capacity of the device 100.

The data object 162 includes header information 166, user data 168, one or more hash values 170 and error correction code (ECC) information 172. The header information 166 may be the LBA value(s) associated with the user data 168 or other useful identifier information. The user data 168 comprise the actual substantive content supplied by the requestor for storage by the device 100.

The hash value 170 can be generated from the user data 168 using a suitable hash function, such as a Sha hash, and can be used to reduce write amplification (e.g., unnecessary duplicate copies of the same data) by comparing the hash value of a previously stored LBA (or range of LBAs) to the hash value for a newer version of the same LBA (or range of LBAs). If the hash values match, the newer version may not need to be stored to the memory structure 104 as this may represent a duplicate set of the same user data.

The ECC information 172 can take a variety of suitable forms such as outercode, parity values, IOEDC values, etc., and is used to detect and correct up to a selected number of errors in the data object during read back of the data.

The metadata unit 164 includes a variety of different types of control data such as data object (DO) address information 174, DO attribute information 176, memory (MEM) attribute information 178, one or more forward pointers 180 and a status value 182. Other metadata unit formats can be used. The address information 174 identifies the physical address of the data object 162, and may provide logical to physical address conversion information as well. The physical address will include which tier (e.g., MEM 1-3 in FIG. 1) stores the data object 162, as well as the physical location within the associated tier at which the data object 162 is stored using appropriate address identifiers such as row (cache line), die, array, plane, erasure block, page, bit offset, and/or other address values.

The DO attribute information 176 identifies attributes associated with the data object 162, such as status, revision level, timestamp data, workload indicators, etc. The memory attribute information 178 constitutes parametric attributes associated with the physical location at which the data object 162 is stored. Examples include total number of writes/erasures, total number of reads, estimated or measured wear effects, charge or resistance drift parameters, bit error rate (BER) measurements, aging, etc. These respective sets of attributes 176, 178 can be maintained by the controller and/or updated based on previous metadata entries.

The forward pointers 180 are used to enable searching for the most current version of the data object 162 by referencing other copies of metadata in the memory structure 104. The status value(s) 182 indicate the current status of the associated data object (e.g., stale, valid, etc.).

The sizes and formats of the data objects 162 and the metadata units 164 can be tailored to the various tiers of the memory structure 104. FIG. 6A depicts a first data object (DO1) that stores a single sector 184 in the user data field 168 (FIG. 5). The sector 184 (LBA X) may be of a standard size such as 512 bytes, etc. FIG. 6B depicts a second data object (DO2) that stores N data sectors 184 (LBA Y to LBA N). The logical addresses of the sectors need not necessarily be consecutive in the manner shown. DO2 will necessarily be larger than DO1.

Corresponding metadata units (not shown) can be formed to describe the first and second data objects DO1 and DO2 and treat each as a separate unit, or block, of data. The granularity of the metadata for DO1 may be smaller than the granularity for DO2 because of the larger amount of user data in DO2.

FIG. 7 is a functional block representation of portions of the device 100 of FIG. 1 in accordance with some embodiments. Operational modules include a data object (DO) storage manager 202, a metadata (MD) storage manager 204 and a garbage collection engine 206. These elements can be realized by the controller 102 of FIG. 1. The memory structure 104 from FIG. 1 is shown to include a number of exemplary tiers including an NV-RAM module 208, an RRAM module 210, a PCRAM module 212, an STRAM module 214, a flash module 216 and a disc module 218. These are merely exemplary as any number of different types and arrangements of memory modules can be used in various tiers as desired.

The NV-RAM 208 comprises volatile SRAM or DRAM with a dedicated battery backup or other mechanism to maintain the stored data in a non-volatile state. The RRAM 210 comprises an array of erasable non-volatile memory cells that store data in relation to different programmed electrical resistance levels responsive to the migration of ions across an interface. The PCRAM 212 comprises an array of phase change memory cells that exhibit different programmed resistances based on changes in phase of a material between crystalline (low resistance) and amorphous (high resistance).

The STRAM 214 comprises an array of memory cells each having at least one magnetic tunneling junction made up of a reference layer of material with a fixed magnetic orientation and a free layer having a variable magnetic orientation. The effective electrical resistance, and hence, the programmed state, of each MTJ can be established in relation to the programmed magnetic orientation of the free layer.

The flash memory 216 comprises an array of flash memory cells which store data in relation to an amount of accumulated charge on a floating gate structure. Unlike the NV-RAM, RRAM, PCRAM and STRAM, which are all contemplated as comprising rewriteable non-volatile memory cells, the flash memory cells are erasable so that an erasure operation is generally required before new data may be written. The flash memory cells can be configured as single level cells (SLCs) or multi-level cells (MLCs) so that each memory cell stores a single bit (in the case of an SLC) or multiple bits (in the case of an MLC).

The disc memory 218 may be magnetic rotatable media such as a hard disc drive (HDD) or similar storage device. Other sequences, combinations and numbers of tiers can be utilized as desired, including other forms of solid-state and/or disc memory, remote server memory, volatile and non-volatile buffer layers, processor caches, intermediate caches, etc.

It is contemplated that each tier will have its own associated memory storage attributes (e.g., capacity, data unit size, I/O data transfer rates, endurance, etc.). The highest order tier (e.g., the NV-RAM 208) will tend to have the fastest I/O data transfer rate performance (or other suitable performance metric) and the lowest order tier (e.g., the disc 218) will tend to have the slowest performance. Each of the remaining tiers will have intermediate performance characteristics in a roughly sequential fashion. At least some of the tiers will have data cells arranged in the form of garbage collection units (GCUs) 152 as discussed previously in FIG. 4.

As shown by FIG. 7, the data object storage manager 204 generates two successive data objects in response to the receipt of different sets of data blocks from the requestor, a first data object (OB1) and a second data object (OB2). These data objects can correspond to the example formats of FIGS. 6A-6B, or can take other forms. The storage manager 202 directs the storage of the DO1 data in the NV-RAM tier 208, and directs the storage of the DO2 data in flash memory tier 216. In some embodiments, the data object storage manager 202 selects an appropriate tier for the data based on a number of data related and/or memory related attributes. In other embodiments, the data object storage manager 202 initially stores all of the data objects in the highest available memory tier and then migrates the data down as needed based on usage or other factors.

The metadata storage manager 204 is shown in FIG. 7 to generate and store two corresponding metadata units MD1 and MD2 for the data objects DO1 and DO2. The metadata storage manager 204 is shown to store the MD1 metadata unit in the PCRAM tier 212 and stores the MD2 metadata unit in the STRAM tier 214. This is merely exemplary, as the metadata units can be stored in any suitable tiers, including the same tiers as the corresponding data objects.

The garbage collection engine 206 implements garbage collection operations upon the GCUs in the various tiers, and provides control inputs to the data object and metadata storage managers 202, 204 to implement migrations of data during such events including demotion of valid data to a lower tier. Operation of the garbage collection engine 206 in accordance with various embodiments will be discussed in greater detail below.

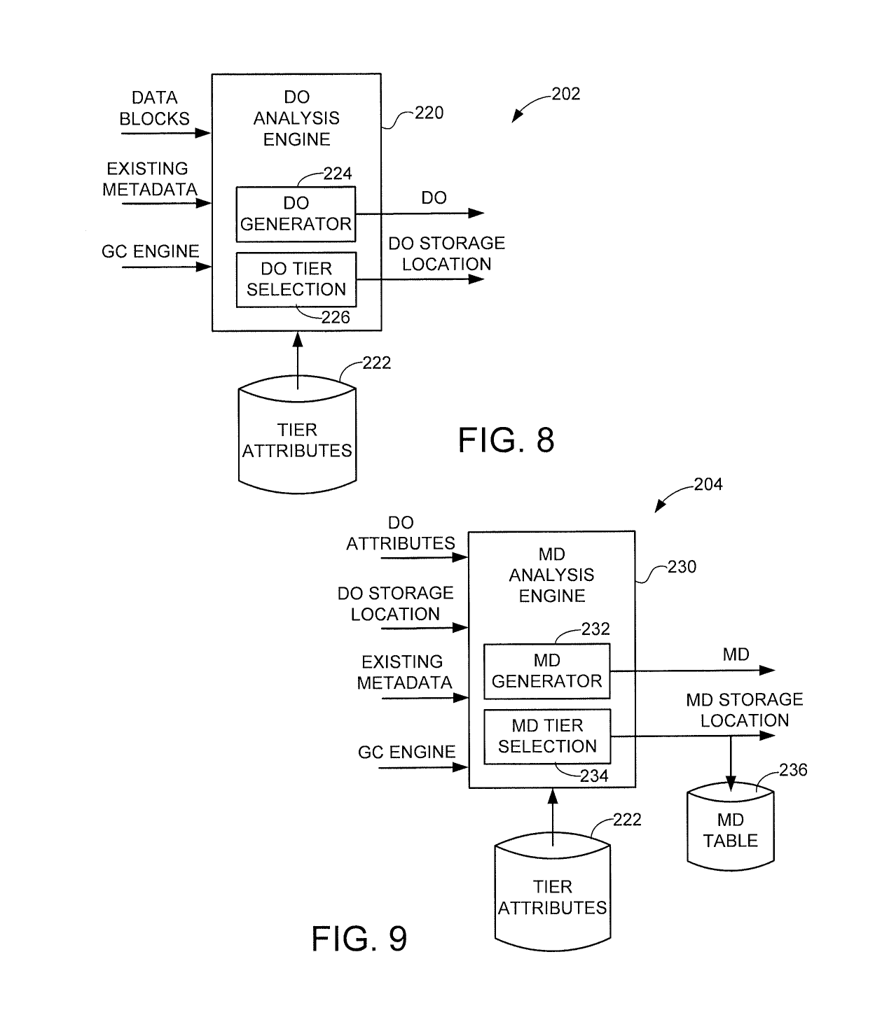

FIG. 8 is a functional representation of the data object storage manager 202 in accordance with some embodiments. A data object (DO) analysis engine 220 receives the data block(s) (LBAs 184) from the requestor as well as existing metadata (MD) stored in the device 100 associated with prior version(s) of the data blocks, if such have been previously stored to the memory structure 104. Memory tier attribute data maintained in a database 222 may be utilized by the engine 220 as well. The engine 220 analyzes the data block(s) to determine a suitable format and location for the data object. The data object is generated by a DO generator 224 using the content of the data block(s) as well as various data-related attributes associated with the data object. A tier selection module 226 selects the appropriate memory tier of the memory structure 104 in which to store the generated data object.

The arrangement of the data object, including overall data object size, may be matched to the selected memory tier; for example, page level data sets may be used for storage to the flash memory 216 and LBA sized data sets may be used for the RRAM, PCRAM and STRAM memories 210, 212 and 214. Other sizes can be used. The unit size of the data object may or may not correspond to the unit size utilized at the requestor level; for example, the requestor may transfer blocks of user data of nominally 512 bytes in size. The data objects may have this same user data capacity, or may have some larger or smaller amounts of user data, including amounts that are non-integer multiples of the requestor block size. The output DO storage location from the DO tier selection module 226 is provided as an input to the memory module 104 to direct the storage of the data object at the designated physical address in the selected memory tier.

FIG. 9 depicts portions of the metadata (MD) storage manager 204 from FIG. 7 in accordance with some embodiments. An MD analysis engine 230 uses a number of factors such as the DO attributes, the DO storage location, the existing MD (if available) and memory tier information from the database 222 to select a format, granularity and storage location for the metadata unit 164. An MD generator 232 generates the metadata unit and a tier selection module 234 selects an appropriate tier level for the metadata. In some cases, multiple data objects may be grouped together and described by a single metadata unit.

As before, the MD tier selection module 234 outputs an MD storage location value that directs the memory structure 104 to store the metadata unit at the appropriate physical location in the selected memory tier. A top level MD data structure such as MD table 236, which may be maintained in a separate memory location or distributed through the memory structure 104, may be updated to reflect the physical location of the metadata for future reference. The MD data structure 236 may be in the form of a lookup table that correlates logical addresses (e.g., LBAs) to the associated metadata units.

Once the data objects and the associated metadata units are stored to the memory structure 104, read and write processing is carried out to service access operations requested by a requestor (e.g. host. A read request for a selected LBA, or range of LBAs, is serviced by locating the metadata associated with the selected LBA(s) through access to the MD data structure 236 or other data structure. The physical location at which the metadata unit is stored is identified and a read operation is carried out to retrieve the metadata unit to a local memory such as a volatile buffer memory of the device 100. The address information for the data object described by the metadata unit is extracted and used to carry out a read operation to retrieve a copy of the user data portion of the data object for transfer to the requestor.

As part of the read operation, the metadata unit may be updated to reflect an increase in the read count for the associated data object. Other parametrics relating to the memory may be recorded as well to the memory tier data structure, such as observed bit error rate (BER), incremented read counts, measured drift parametrics, etc. It is contemplated, although not necessarily required, that the new updated metadata unit will be maintained in the same memory tier as before.

In the case of rewriteable memory tiers (e.g., tiers 208-216 and 218 in FIG. 7), the new updates to the metadata (e.g., incremented read count, state information, etc.) may be overwritten onto the existing metadata for the associated data object. For metadata stored to an erasable memory tier (e.g., flash memory 216), the metadata unit (or a portion thereof) may be written to a new location in the tier.

It is noted that a given metadata unit may be distributed across the different tiers so that portions requiring frequent updates are stored in one tier that can easily accommodate frequent updates (such as a rewriteable tier and/or a tier with greater endurance) and more stable portions of the metadata that are less frequently updated can be maintained in a different tier (such as an eraseable tier and/or a tier with lower endurance).

During the writing of new data to the memory structure 104, a write command and an associated set of user data are provided from the requestor to the device 100. As before, an initial metadata lookup operation locates a previously stored most current version of the data, if such exists. If so, the metadata are retrieved and a preliminary write amplification filtering analysis may take place to ensure the newly presented data represent a different version of data. This can be carried out using the hash values 170 in FIG. 5.

A data object 162 (FIG. 2) is generated and an appropriate memory tier level for the data object is selected. A corresponding metadata unit 164 is generated and an appropriate memory tier level is selected. The data object and the metadata unit are stored in the selected tier(s). It will be noted that in the case where a previous version of the data is resident in the memory structure 104, the new data object and the new metadata unit may, or may not, be stored in the same respective memory tier levels as the previous version data object and metadata unit. The previous version data object and metadata may be marked stale and adjusted as required, such as by the addition of one or more forward pointers in the old MD unit to point to the new location.

The metadata granularity is selected based on characteristics of the corresponding data object. As used herein, granularity generally refers to the unit size of user data described by a given metadata unit; the smaller the metadata granularity, the smaller the unit size and vice versa. As the metadata granularity decreases, the size of the metadata unit may increase. This is because the metadata needed to describe 1 megabyte (MB) of user data as a single unit (large granularity) would be significantly smaller than the metadata required to individually describe each 16 bytes (or 512 bytes, etc.) of that same 1 MB of user data (small granularity).

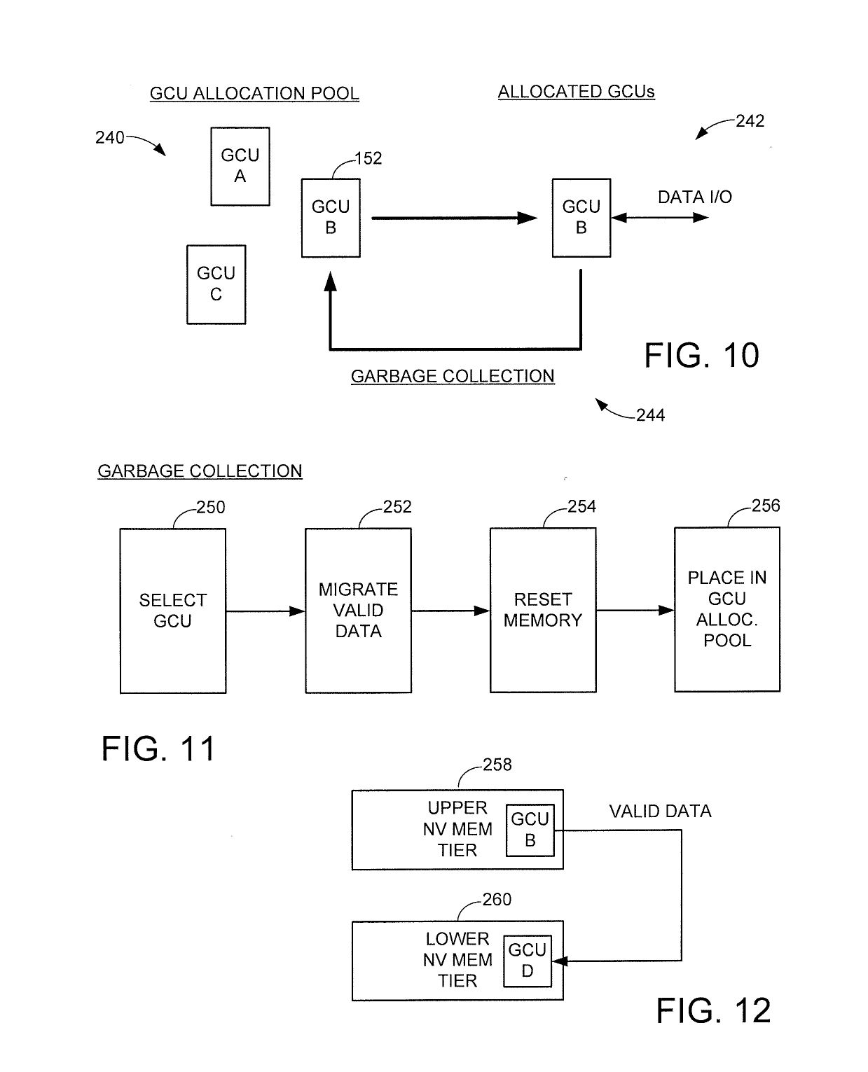

FIG. 10 depicts the operational life cycle of various GCUs 152 (FIG. 2) in a given memory tier (FIG. 7). A GCU allocation pool 240 represents various GCUs, three of which are identified as GCU A, GCU B and GCU C, that are available for allocation for the storage of new data objects and/or metadata. Once the storage managers 202, 204 select a new GCU for allocation, the selected GCU (in this case, GCU B) is operationally transitioned to an allocated GCU state 242. While the GCU is in the allocated state 242, data input/output (I/O) operations are carried out to store new data to the GCU and read previously stored data from the GCU.

At some point the GCU is selected for garbage collection as indicated by state 244. As noted above, the garbage collection processing is directed by the garbage collection engine 206 in FIG. 7 and serves to place the GCU back into the GCU allocation pool 240.

FIG. 11 depicts the garbage collection process in accordance with some embodiments. The various steps can be carried out at suitable times, such as in the background during times with relatively low requestor processing levels. The GCU is selected at step 250. The selected GCU may store data objects, metadata units or both (collectively, “data sets”). The garbage collection engine 206 examines the state of each of the data sets in the selected GCU to determine which represent valid data and which represent stale data. Stale data sets may be indicated from the metadata or from other data structures as discussed above. It will be appreciated that stale data sets generally represent data sets that do not require continued storage, and so can be jettisoned. Valid data sets should be retained, such as because the data sets represent the most current version of the data, the data sets are required in order to access other data (e.g., metadata units having forward pointers that point to other metadata units, etc.), and so on.

The valid data sets from the selected GCU are migrated at step 252. It is contemplated that in most cases, the valid data sets will be copied to a new location in a lower memory tier in the memory structure 104. Such is not necessarily required, however. Depending on the requirements of a given application, at least some of the valid data sets may be retained in a different GCU in the same memory tier based on data access requirements, etc. Also, in other cases the migrated data set may be advanced to a higher tier. It will be appreciated that all of the demoted data may be sent to the same lower tier, or different ones of the demoted data sets may be distributed to different lower tiers.

The memory cells in the selected GCU are next reset at step 254. This operation will depend on the construction of the memory. In a rewritable memory such as the PCRAM tier 212, for example, the phase change material in the cells in the GCU may be reset to a lower resistance crystalline state. In an erasable memory such as the flash memory tier 216, an erasure operation may be applied to the flash memory cells to remove substantially all of the accumulated charge from the floating gates of the flash memory cells to reset the cells to an erased state.

It will be appreciated that resetting the memory cells to a known state can be beneficial for a number of reasons. Restoring the cells to a known programming state simplifies subsequent write operations, since if all of the cells have a first logical state (e.g., logical “0,” logical “11,” etc.) then only those bit locations in the input write data that are different from the known baseline state need be written. Also, to the extent that extensive write and/or read operations have introduced drift characteristics into the state of the cells, restoring the cells to a known baseline (such as via an erasure operation or a special write operation) can reduce the effects of such drift or other characteristics.

However, it will be appreciated that it is not necessarily required that the cells be altered. In other embodiments, the cells are invalidated such as by setting a status flag associated with the cells that indicates that the programmed states of the cells do not reflect valid data. The actual programmed states of the cells may thereafter remain unchanged. New data are thereafter overwritten onto the cells as required. This latter approach may not be as suitable for use in erasable cells as it may be using rewritable cells.

Regardless whether the reset operation involves changing the programmed states of the cells, it will be appreciated that once the selected GCU has been reset, the GCU is returned to the GCU allocation pool at step 256 pending subsequent reallocation by the system. The selected GCU is thus ready and available to store new data sets as required.

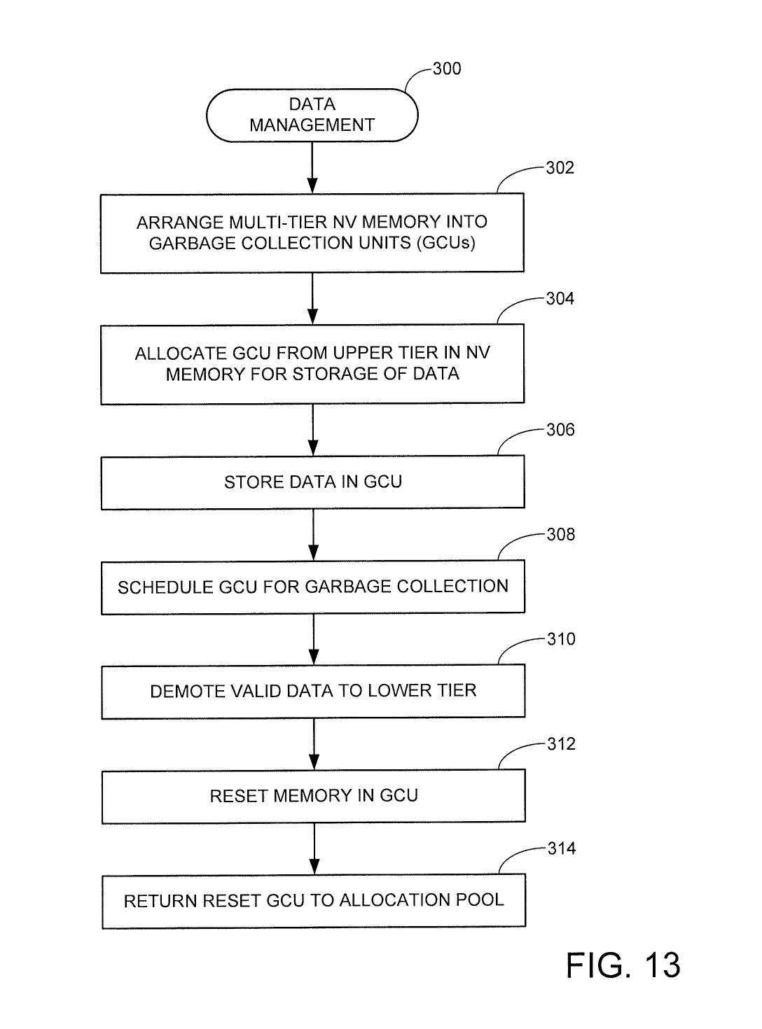

FIG. 12 depicts the migration of the data sets in step 252 of FIG. 11. At least some of the migrated data are copied from the selected GCU B in an upper non-volatile (NV) memory tier 258 to a currently or newly allocated GCU (GCU D) in a lower NV memory tier 260. As used herein, a higher or upper tier such as 258 will be understood as a memory having a higher priority in the sequence of memory locations as compared to the lower tier such as 260. Thus, searches for data, for example, may be performed on the upper tier 258 prior to the lower tier 260. Similarly, higher priority data may be initially stored in the upper tier 258 and lower priority data may be stored in the lower tier 260. In another aspect, all other factors being equal, if space is available in both the upper and lower tiers, the system may tend to store the data in the higher available tier based on a number of factors such as cost, performance, endurance, etc. It will be noted that the upper tier 258 may have a smaller capacity and/or faster data I/O transfer rate performance than the lower tier 260, although such is not necessarily required.

The garbage collection engine 206 thus accumulates data in a higher tier of memory, and upon eviction the remaining valid data are demoted to a lower tier of memory. The size of the data object may be adjusted to better conform to storage attributes of the lower memory tier.

In some cases, the next lower tier is selected for the storage of the demoted data. If certain data are not updated and thus remain valid over an extended period of time, the data may be sequentially pushed lower and lower into the memory structure until the lowest available memory tier is reached. Other factors that indicate data demotion should not take place, such as relatively high read counts, etc., may result in some valid data sets not being demoted but instead staying in the same memory tier (in a new location) or even being promoted to a higher tier.

In this scheme, all of the data may be initially written to the highest available tier and, over time, usage rates will allow the data to “sink” to the appropriate levels within the tier structure. More frequently updated data will thus tend to “rise” or stay proximate the upper tier levels.

In further cases, demoted data may be moved two or more levels down from an existing upper tier. This can be suitable in cases, for example, where the data set attributes tend to match the criteria for the lower tier, such as a large data set or a data set with a low update frequency.

In these and other approaches, a relative least recently used (LRU) scheme can be implemented so that the current version data, which by definition will be the “oldest” data in a given GCU in terms of not having been updated relative to its peers, can be readily selected for demotion with no further metric calculations being necessary.

FIG. 13 provides a flow chart for a DATA MANAGEMENT routine 300 carried out in accordance with various embodiments. The routine may represent programming utilized by the device controller 102. The routine 300 will be discussed in view of the foregoing exemplary structures of FIGS. 7-12, although such is merely for purposes of illustration. The various steps can be omitted, changed or performed in a different order. For clarity, it is contemplated that the routine of FIG. 13 will demote valid data to a lower tier and will proceed to reset the cells during garbage collection operations so that all of the cells are erased or otherwise reset to a common programmed state. Such is illustrative and not necessarily required in all embodiments.

At step 302, a multi-tier non-volatile (NV) memory such as the memory structure 104 is provided with multiple tiers such as the tiers 208-218 in FIG. 7. Each tier may have its own construction, size, performance, endurance and other attributes. At least one tier, and in some cases all of the tiers, are respectively arranged so as to provide a plurality of garbage collection units (GCUs) adapted for the storage of multiple blocks of user data. The number and respective sizes of the GCUs will vary depending on the application, but it will be noted that the various GCUs will be allocated, addressed, used and reset as individual units of memory. Sufficient capacity should be provided in each GCU to accommodate multiple data write operations of different data objects before requiring a garbage collection operation.

At step 304, a selected GCU is allocated from an upper tier memory for the storage of data. One example is the GCU B discussed in FIGS. 10-12. Data are thereafter stored in the selected GCU at step 306 during a normal operational phase. The time during this phase will depend on the application, but it is contemplated that this will represent a relatively extended period of time (e.g., days, weeks and/or months rather than hours or minutes, although such is not necessary limiting).

At some point at the end of this time period, the selected GCU will be selected for garbage collection, as indicated at step 308. The decision to carry out a garbage collection operation can be made by the garbage collection engine 206 of FIG. 7 based on a variety of factors.

In some cases, garbage collection is not considered while the GCU still has available data memory cells that have not yet been used for the storage of data; that is, the GCU will need to at least have been substantially “filled up” with data before garbage collection is applied. However, it is contemplated that in some cases, garbage collection may be applied even in the case where less than all of the data capacity of the GCU has been allocated for the storage of data.

In further cases, garbage collection may be initiated once a selected percentage of the data sets stored in the GCU become stale. For example, once a selected threshold of X % of the stored data is stale, the GCU may be selected for garbage collection.

In still other cases, performance metrics such as drift, read/write counts, bit error rate, etc. may signal the desirability of garbage collecting a GCU. For example, a particular GCU may store a large percentage of valid data, but measured performance metrics indicate that the memory cells are becoming degraded. Charge drift may be experienced on flash memory cells from direct and/or adjacent reads and writes, indicating the data are becoming increasingly read disturbed or write disturbed. Similarly, a set of RRAM or PCRAM cells may begin to exhibit resistance drift after repeated rewrite and/or read operations, indicating the desirability of resetting all of the cells to a known state.

An aging factor may be used to select the initiation of the garbage collection process; for example, once the data have been stored a certain interval (either measured as an elapsed period of time or a total number of I/O events), it may become desirable to perform a garbage collection operation to recondition the GCU and return it to service. Any number of other storage memory and data related attributes can be factored into the decision to apply garbage collection to a given GCU.

The garbage collection operation is next carried out beginning at step 310. During the garbage collection operation, valid data sets in the selected GCU are identified and migrated to one or more new storage locations. As discussed above, at least some of the migrated valid data sets will be demoted to a lower memory tier, as depicted in FIG. 12.

Once the valid data sets have been copied, the memory cells in the selected GCU are next reset at step 312. The form of the reset operation will depend on the construction of the memory; the memory cells in rewritable memory tiers such as 208-214, 220 may be reset by a simple write operation to write the same data value (e.g., logical “1”) to all of the memory cells. In other embodiments, a more thorough reset operation may be applied so that conditioning is applied to the memory cells as the cells are returned to a known state. Similarly, the erasable memory cells such as in the flash memory tier 216 may be subjected to an erasure operation during the reset operation.

Finally, the reset GCU is returned to an allocation pool in the selected memory tier at step 314, as depicted in FIG. 10, pending subsequent reallocation for the storage of new data.

The GCUs in the various memory tiers may be of any suitable data capacity size, and can be adjusted over time as required. Demoting the valid data during garbage collection provides an efficient mechanism for adaptive memory tier level adjustment based on actual usage characteristics.

It is contemplated, although not necessarily required, that each memory tier in the multi-tiered memory structure 104 will store both data objects and metadata units (albeit not necessarily related to each other). It follows that there will be a trade-off in determining how much memory capacity in each tier should be allocated for the storage of data objects, and how much memory capacity in each tier should be allocated for the storage of metadata. The respective percentages (e.g., X % for data objects and 100-X % for metadata units) for each memory tier may be adaptively adjusted based on the various factors listed above. Generally, it has been found that enhanced performance may arise through the use of higher memory tiers for the metadata in small random write environments so that the granularity of the metadata can be adjusted to reduce the incidence of read-modify-writes on the data objects.

As used herein, “erasable” memory cells and the like will be understood consistent with the foregoing discussion as memory cells that, once written, can be rewritten to less than all available programmed states without an intervening erasure operation, such as in the case of flash memory cells that require an erasure operation to remove accumulated charge from a floating gate structure. The term “rewritable” memory cells and the like will be understood consistent with the foregoing discussion as memory cells that, once written, can be rewritten to all other available programmed states without an intervening reset operation, such as in the case of NV-RAM, RRAM, STRAM and PCRAM cells which can take any initial data state (e.g., logical 0, 1, 01, etc.) and be written to any of the remaining available logical states (e.g., logical 1, 0, 10, 11, 00, etc.).

Numerous characteristics and advantages of various embodiments of the present disclosure have been set forth in the foregoing description, together with structural and functional details. Nevertheless, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising:
arranging a non-volatile first tier of a multi-tier memory structure into a plurality of garbage collection units (GCUs) each comprising a plurality of non-volatile memory cells managed as a unit;
storing a plurality of data sets in a selected GCU; and
performing a garbage collection operation upon the selected GCU by identifying at least one of the plurality of data sets as a valid data set, migrating the valid data set to a different, non-volatile second tier of the multi-tier memory structure, and invalidating a data state of each of the plurality of non-volatile memory cells in the selected GCU to prepare the selected GCU to store new data.

2. The method of claim 1, in which the plurality of non-volatile memory cells in the selected GCU are invalidated by resetting each of said memory cells to a known programmed state.

3. The method of claim 2, in which the resetting of each of said memory cells comprises performing an erasure operation upon said memory cells.

4. The method of claim 2, in which the resetting of each of said memory cells comprises overwriting the same selected logical state to each of said memory cells.

5. The method of claim 1, in which the second tier of the multi-tier memory structure is arranged into a plurality of GCUs each comprising a plurality of non-volatile memory cells, and the migrated valid data set is stored during the garbage collection operation to a second selected GCU in the second tier.

6. The method of claim 1, in which the first tier comprises an upper tier of the memory structure and the second tier comprises a lower tier of the memory structure, the upper tier having a faster data input/output (I/O) unit data transfer rate than a data I/O unit data transfer rate of the lower tier.

7. The method of claim 6, in which the plurality of non-volatile memory cells of the selected GCU in the upper tier comprise rewritable non-volatile memory cells, and the lower tier comprises a second selected GCU to which the migrated valid data set is written, the second selected GCU comprising a plurality of erasable non-volatile memory cells.

8. The method of claim 7, in which each of the rewritable non-volatile memory cells comprises a programmable resistive sense element (RSE) in combination with a switching device.

9. The method of claim 1, in which a second valid data set from the selected GCU is migrated to a second GCU in the first tier during the garbage collection operation.

10. The method of claim 1, in which the multi-tier memory structure comprises a plurality of tiers in a priority order from a fastest memory tier to a slowest memory tier, and the second tier is immediately below the first tier in said priority order.

11. The method of claim 1, in which the garbage collection operation further comprises resetting each of the memory cells of the selected GCU to a common programming state and returning the selected GCU to an allocation pool of available GCUs pending subsequent reallocation for storage of new data sets.

12. An apparatus comprising:
a multi-tier memory structure comprising a plurality of non-volatile memory tiers each having different data transfer attributes and corresponding memory cell constructions, wherein an upper memory tier in the multi-tier memory structure is arranged into a plurality of garbage collection units (GCUs), each GCU comprising a plurality of non-volatile memory cells that are allocated and reset as a unit;
a storage manager adapted to store a plurality of data sets in a selected GCU in the upper memory tier; and
a garbage collection engine adapted to perform a garbage collection operation upon the selected GCU by identifying at least one of the plurality of data sets as a valid data set, demoting the valid data set to a non-volatile lower tier of the multi-tier memory structure, and invalidating a storage state of each of the plurality of non-volatile memory cells in preparation for storage of new data to the selected GCU.

13. The apparatus of claim 12, in which the lower tier of the multi-tier memory structure is arranged into a plurality of GCUs each comprising a plurality of non-volatile memory cells, the demoted valid data set stored during the garbage collection operation to a second selected GCU in the lower tier.

14. The apparatus of claim 12, in which the storage manager is characterized as a data object storage manager which generates a plurality of data objects comprising user data supplied by a requestor for storage in the multi-tier memory structure.

15. The apparatus of claim 12, in which the plurality of memory cells in the selected GCU are characterized as erasable flash memory cells and the cells are reset during the invalidation operation using an erasure operation.

16. The apparatus of claim 12, in which the plurality of memory cells in the selected GCU are characterized as rewritable resistive sense element (RSE) cells and the cells are reset during the invalidation operation by writing the same programmed electrical resistance state to each of the cells.

17. The apparatus of claim 12, in which the lower memory tier is automatically selected as the next immediately lower tier below the upper memory tier in a priority order of the respective memory tiers in the multi-tier memory structure.

18. The apparatus of claim 12, in which the lower memory tier is selected from a plurality of available lower tiers in the memory structure responsive to a data attribute of the demoted valid data set.

19. An apparatus comprising:
a multi-tier memory structure comprising a plurality of non-volatile memory tiers each having different data transfer attributes and corresponding memory cell constructions, wherein an upper memory tier in the multi-tier memory structure is arranged into a plurality of garbage collection units (GCUs), each GCU comprising a plurality of non-volatile memory cells that are allocated and reset as a unit; and
a controller adapted to allocate a selected GCU for storage of data from a GCU allocation pool, to store a plurality of data sets in the allocated selected GCU, and to subsequently garbage collect the selected GCU to return the selected GCU to the GCU allocation pool by demoting a valid data set to a lower memory tier and resetting the plurality of non-volatile memory cells in the selected GCU to a known storage state.

20. The apparatus of claim 19, in which the upper memory tier comprises rewritable non-volatile memory cells and the lower memory tier comprises erasable non-volatile memory cells.
